(19) United States
(12) Patent Application Publication
(10) Pub. No.: US 2013/0167566 A1
(43) Pub. Date: Jul. 4, 2013

(54) Ejectors and Methods of Manufacture

(71) Applicant: Abbas A. Alahyari, Manchester, CT (US)

(72) Inventor: Abbas A. Alahyari, Manchester, CT (US)

(73) Assignee: Carrier Corporation, Farmington, CT (US)

(21) Appl. No.: 13/821,384

(22) PCT Filed: May 10, 2012
(86) PCT No.: PCT/US12/37272

§ 371 Date: Mar. 7, 2013

Related U.S. Application Data
(60) Provisional application No. 61/489,035, filed on May 23, 2011.

(51) Int. Cl. F25D 15/00; B05B 1/00

(52) U.S. Cl. CPC F25D 15/00; B05B 1/00
USPC 62/115; 239/418; 62/401; 29/428

(57) ABSTRACT

An ejector (200; 400; 600; 700; 800) has a housing (202) and an insert. The housing has an upstream end (206) and a downstream end (208) and a branch (220). A primary flowpath extends from the upstream end and a secondary flowpath passes through the branch to join the primary flowpath. The insert (204; 402) is within the housing and extends from an upstream end (250) to a downstream end (252). The insert has a motive nozzle (240) having an inlet and an outlet. A mixer (242) is at least partially downstream of the motive nozzle. One or more passages (304) are positioned such that the secondary flowpath extends through the branch and through the one or more passages to join the primary flowpath, at least one portion of the insert being of less robust material than a material of the housing.

### CROSS-REFERENCE TO RELATED APPLICATION

Benefit is claimed of U.S. Patent Application Ser. No. 61/489,035, filed May 23, 2011, and entitled “Ejector and Methods of Manufacture”, the disclosure of which is incorporated by reference herein in its entirety as if set forth at length.

### BACKGROUND

The present disclosure relates to refrigeration. More particularly, it relates to ejector refrigeration systems.

Earlier proposals for ejector refrigeration systems are found in U.S. Pat. No. 1,836,318 and U.S. Pat. No. 3,277,660. FIG. 1 shows one basic example of an ejector refrigeration system 20. The system includes a compressor 22 having an inlet (suction port) 24 and an outlet (discharge port) 26. The compressor and other system components are positioned along a refrigerant circuit or flowpath 27 and connected via various conduits (lines). A discharge line 28 extends from the outlet 26 to the inlet 32 of a heat exchanger (a heat rejection heat exchanger in a normal mode of system operation (e.g., a condenser or gas cooler)) 30. A line 36 extends from the outlet 34 of the heat rejection heat exchanger 30 to a primary inlet (liquid or supercritical or two-phase inlet) 40 of an ejector 38. The ejector 38 also has a secondary inlet (saturated or superheated vapor or two-phase inlet) 42 and an outlet 44. A line 46 extends from the ejector outlet 44 to an inlet 50 of a separator 48. The separator has a liquid outlet 52 and a gas outlet 54. A suction line 56 extends from the gas outlet 54 to the compressor suction port 24. The lines 28, 36, 46, 56, and components therebetween define a primary loop 60 of the refrigerant circuit 27. A secondary loop 62 of the refrigerant circuit 27 includes a heat exchanger 64 (in a normal operational mode being a heat absorption heat exchanger (e.g., evaporator)). The evaporator 64 includes an inlet 66 and an outlet 68 along the secondary loop 62. An expansion device 70 is positioned in a line 72 which extends between the separator liquid outlet 52 and the evaporator inlet 66. An ejector secondary inlet line 74 extends from the evaporator outlet 68 to the ejector secondary inlet 42.

In the normal mode of operation, gaseous refrigerant is drawn by the compressor 22 through the suction line 56 and inlet 24 and compressed and discharged from the discharge port 26 into the discharge line 28. In the heat rejection heat exchanger, the refrigerant loses/rejects heat to a heat transfer fluid (e.g., fan-forced air or water or other fluid). Cooled refrigerant exits the heat rejection heat exchanger via the outlet 34 and enters the ejector primary inlet 40 via the line 36.

The exemplary ejector 38 (FIG. 2) is formed as the combination of a motive (primary) nozzle 100 nested within an outer member 102. The primary inlet 40 is the inlet to the motive nozzle 100. The outlet 44 is the outlet of the outer member 102. The primary refrigerant flow 103 enters the inlet 40 and then passes into a convergent section 104 of the motive nozzle 100. It then passes through a throat section 106 and an expansion (divergent) section 108 through an outlet (exit) 110 of the motive nozzle 100. The motive nozzle 100 accelerates the flow 103 and decreases the pressure of the flow. The secondary inlet 42 forms an inlet of the outer member 102. The pressure reduction caused to the primary flow by the motive nozzle helps draw the secondary flow 112 into the outer member. The outer member includes a mixer having a convergent section 114 and an elongate throat or mixing section 116. The outer member also has a divergent section or diffuser 118 downstream of the elongate throat or mixing section 116. The motive nozzle outlet 110 is positioned within the convergent section 114. As the flow 103 exits the outlet 110, it begins to mix with the flow 112 with further mixing occurring through the mixing section 116 which provides a mixing zone. Thus, respective primary and secondary flowpaths extend from the primary inlet and secondary inlet to the outlet, merging at the exit. In operation, the primary flow 103 may typically be supercritical upon entering the ejector and subcritical upon exiting the motive nozzle. The secondary flow 112 is gaseous (or a mixture of gas with a smaller amount of liquid) upon entering the secondary inlet port 42. The resulting combined flow 120 is a liquid/vapor mixture and decelerates and recovers pressure in the diffuser 118 while remaining a mixture. Upon entering the separator, the flow 120 is separated back into the flows 103 and 112. The flow 103 passes as a gas through the compressor suction line as discussed above. The flow 112 passes as a liquid to the expansion valve 70. The flow 112 may be expanded by the valve 70 (e.g., to a low quality (two-phase with small amount of vapor)) and passed to the evaporator 64. Within the evaporator 64, the refrigerant absorbs heat from a heat transfer fluid (e.g., from a fan-forced air flow or water or other liquid) and is discharged from the outlet 68 to the line 74 as the aforementioned gas.

Use of an ejector serves to recover pressure/work. Work recovered from the expansion process is used to compress the gaseous refrigerant prior to entering the compressor. Accordingly, the pressure ratio of the compressor (and thus the power consumption) may be reduced for a given desired evaporator pressure. The quality of refrigerant entering the evaporator may also be reduced. Thus, the refrigeration effect per unit mass flow may be increased (relative to the non-ejector system). The distribution of fluid entering the evaporator is improved (thereby improving evaporator performance). Because the evaporator does not directly feed the compressor, the evaporator is not required to produce superheated refrigerant outflow. The use of an ejector cycle may thus allow reduction or elimination of the superheated zone of the evaporator. This may allow the evaporator to operate in a two-phase state which provides a higher heat transfer performance (e.g., facilitating reduction in the evaporator size for a given capability).

The exemplary ejector may be a fixed geometry ejector or may be a controllable ejector. FIG. 2 shows controllability provided by a needle valve 130 having a needle 132 and an actuator 134. The actuator 134 shifts a tip portion 136 of the needle into and out of the throat section 106 of the motive nozzle 100 to modulate flow through the motive nozzle and, in turn, the ejector overall. Exemplary actuators 134 are electric (e.g., solenoid or the like). The actuator 134 may be coupled to and controlled by a controller 140 which may receive user inputs from an input device 142 (e.g., switches, keyboard, or the like) and sensors (not shown). The controller 140 may be coupled to the actuator and other controllable system components (e.g., valves, the compressor motor, and the like) via control lines 144 (e.g., hardwired or wireless communication paths). The controller may include one or more: processors; memory (e.g., for storing program information for execution by the processor to perform the operational methods and for storing data used or generated by the program(s)); and hardware interface devices (e.g., ports) for interfacing with input/output devices and controllable system components.

### SUMMARY

One aspect of the disclosure involves an ejector having a housing and an insert. The housing has an upstream end and a downstream end and a branch. A primary flowpath extends from the upstream end and a secondary flowpath passes through the branch to join the primary flowpath. The insert is within the housing and extends from an upstream end to a downstream end. The insert has a motive nozzle having an inlet and an outlet. A mixer is at least partially downstream of the motive nozzle. One or more passages are positioned such that the secondary flowpath extends through the branch and through the one or more passages to join the primary flowpath, at least one portion of the insert being of less robust material than a material of the housing.

In various implementations, the insert may further comprise a radially outwardly open channel open to the branch. The one or more passages may extend from a channel such that the secondary flowpath extends through the branch into the channel and through the one or more passages to join the primary flowpath. The one or more passages may comprise a circumferential array of a plurality of passages. The insert may be essentially unitarily formed as a single piece (e.g., ignoring seals, sealants, adhesives, coatings, and the like). A single piece may comprise a casting. The insert may alternatively consist essentially of two pieces: a first piece forming the motive nozzle; and a second piece forming the mixer and the one or more passages.

A needle may be mounted for reciprocal movement along the primary flowpath between a first position and a second position. A needle actuator may be coupled to the needle to drive the movement of the needle relative to the motive nozzle.

Other aspects of the disclosure involve a refrigeration system having a compressor, a heat rejection heat exchanger coupled to the compressor to receive refrigerant compressed by the compressor, a heat absorption heat exchanger, a separator, and such an ejector. An inlet of the separator may be coupled to the outlet of the ejector to receive refrigerant from the ejector.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a schematic view of a prior art ejector refrigeration system.

FIG. 2 is an axial sectional view of a prior art ejector.

FIG. 3 is an axial sectional view of an ejector.

FIG. 4 is an axial sectional view of an insert of the ejector of FIG. 3.

FIG. 5 is an axial sectional view of a second ejector.

FIG. 6 is an axial sectional view of a third ejector.

FIG. 7 is an axial sectional view of a fourth ejector.

FIG. 8 is an axial sectional view of a fifth ejector.

Like reference numbers and designations in the various drawings indicate like elements.

### DETAILED DESCRIPTION

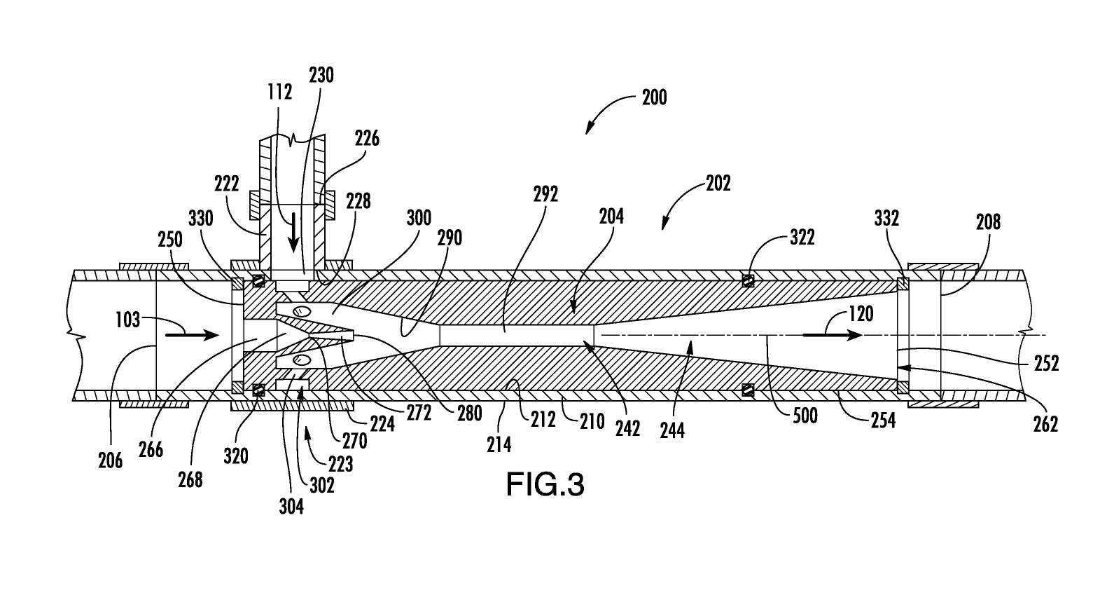

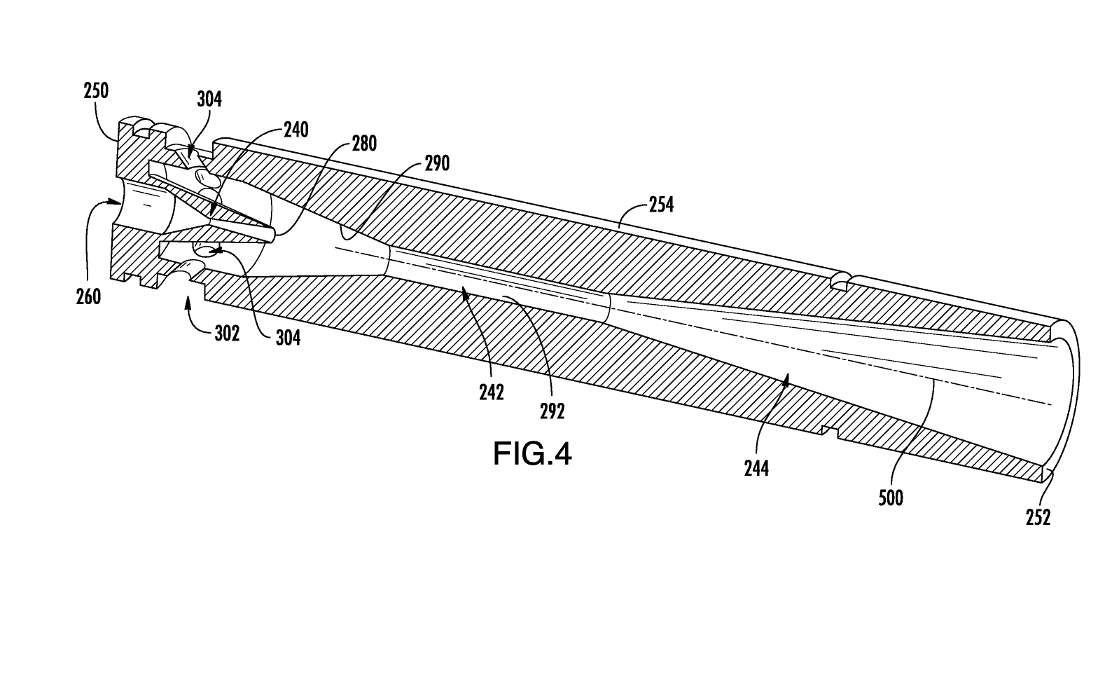

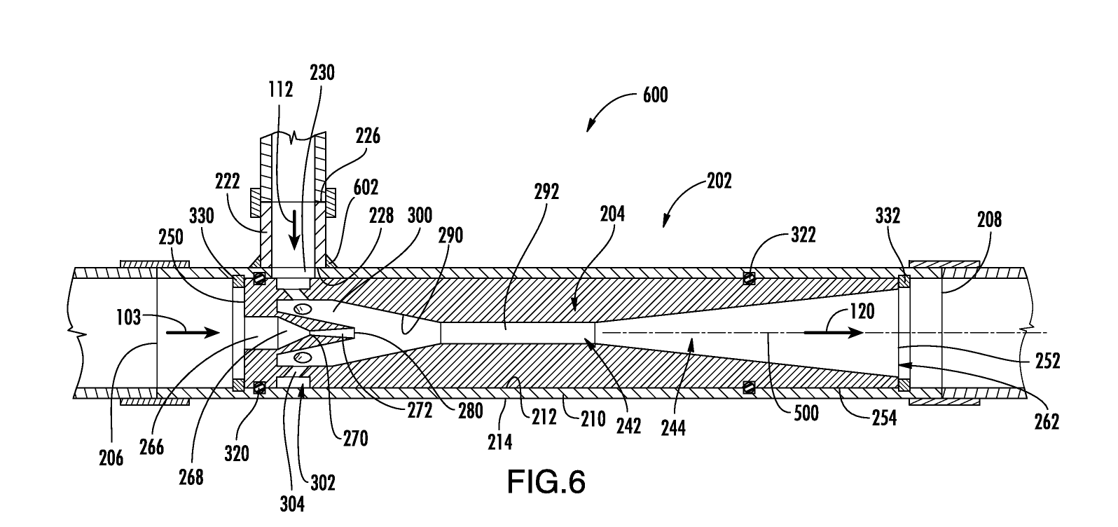

FIG. 3 shows an ejector 200 comprising a housing 202 and an insert 204 within the housing. The housing extends from an upstream end 206 which forms a primary (motive flow) inlet to a downstream end 208 which forms a primary (combined flow) outlet. The exemplary housing may provide substantial structural integrity to the ejector to withstand pressure differences. Accordingly, an exemplary housing comprises a main metallic tube or pipe 210 (e.g., stainless steel) extending between and sharing the upstream and downstream ends 206 and 208. The pipe has an interior (inner diameter) (ID) surface 212 and an exterior (outer diameter) (OD) surface 214. The pipe 210 has a central longitudinal axis 500. The housing further includes a branch 220 transverse to the pipe. An exemplary branch is formed by a leg 222 of a T-fitting 223 (e.g., also stainless steel). The T-fitting has a head 224 through which the pipe 210 is inserted. After insertion, the T-fitting and pipe may be welded or brazed to each other. The pipe 210 has a lateral aperture 230 open to the leg 222. The leg 222 extends along a suction flowpath from an upstream end 226 of the leg to a downstream end 228 of the leg. In alternative implementations, the leg may be a tube/pipe welded directly to the pipe 210 at the end 208 (e.g. prior to drilling the aperture 230). FIG. 6 shows such an alternative ejector 600 having a large structural weld 602 securing the leg 222 as a short sub or boss to the pipe 210.

The insert 204 defines the motive nozzle 240, mixer 242, and diffuser 244. Use of an insert allows for substantial manufacturing flexibility. For example, it allows for materials and techniques to be used for the insert which might not be effective to produce a sufficiently robust one-piece nozzle to withstand operational pressures (while a more robust material is used for the housing (e.g., harder, stiffer, tougher, more wear-resistant, and the like and likely denser). It also provides opportunities for customization and optimization. Inserts may be made by various so-called rapid prototyping or 3D printing techniques such as those involving laser sintering of ceramic, metal, and/or polymer materials or those involving laser curing of epoxy or other polymer materials. Alternative techniques involve casting of metal (e.g., a relatively light metal such as aluminum) or molding of a non-metallic material such as a plastic (e.g., injection molding of PVC). Use of an insert may also provide overall weight reduction which may be particularly relevant to transportation refrigeration systems. The insert or one of its pieces may consist essentially of the less robust material or the less robust material may make up a majority of the insert by mass or volume.

The exemplary insert extends from an upstream end 250 to a downstream end 252 and has an OD surface 254. Subject to recesses, etc. described below, an exemplary OD surface 254 may be circular cylindrical with sufficient tolerance to closely slide into the pipe 210.

The upstream end includes an inlet 260 to the motive nozzle. The downstream end includes a combined outlet 262. The exemplary motive nozzle includes a relatively constant cross-section upstream portion 266 followed by a convergent portion 268, a throat 270, a divergent portion 272, and an exit 280. The exemplary exit 280 is received within a convergent portion 290 of the mixer which, in turn, leads to a straight portion 292 and then to the diffuser 244.

A secondary inlet plenum 300 surrounds the motive nozzle at the upstream end of the convergent section 290. In the exemplary embodiment, there is an annular channel 302 open to the OD surface of the insert at the port 230 so as to be in communication with the secondary flowpath. A circumferential array of passages 304 extend between the base of the channel and the outer surface of the interior of the plenum 300. Accordingly, suction flow may enter from the leg 222 passing through the port 230 into the channel 302, through the passages 304, into the plenum 300, and downstream into the mixer to mix with the motive flow.

For sealing the insert to the housing, the exemplary ejector has an upstream seal (e.g., polymeric/elastomeric O-ring) 320 and a downstream seal (e.g., polymeric/elastomeric O-ring) 322. The exemplary O-rings 320 and 322 are captured in an associated pair of complementary channels in the ID surface 212 of the pipe and the OD surface 254 of the insert.

To retain the insert axially in position, the perimeters of the upstream and downstream ends of the insert abut respective retaining clips (e.g., C-clips) 330, 332 in associated channels in the ID surface of the pipe. Static friction or stiction (e.g., between the insert and O-rings on the one hand and the pipe and O-rings on the other hand) may provide the limited required force to rotationally retain the insert against rotation about the axis 500. Alternative axial retention/retaining means include one or more set screws (e.g., threaded into one of the insert and pipe and pressing against the other) or one or more pins (e.g., in bores in one or both of the insert and pipe). Such set screw(s) or pin(s) may additionally retain the insert against rotation about the axis 500.

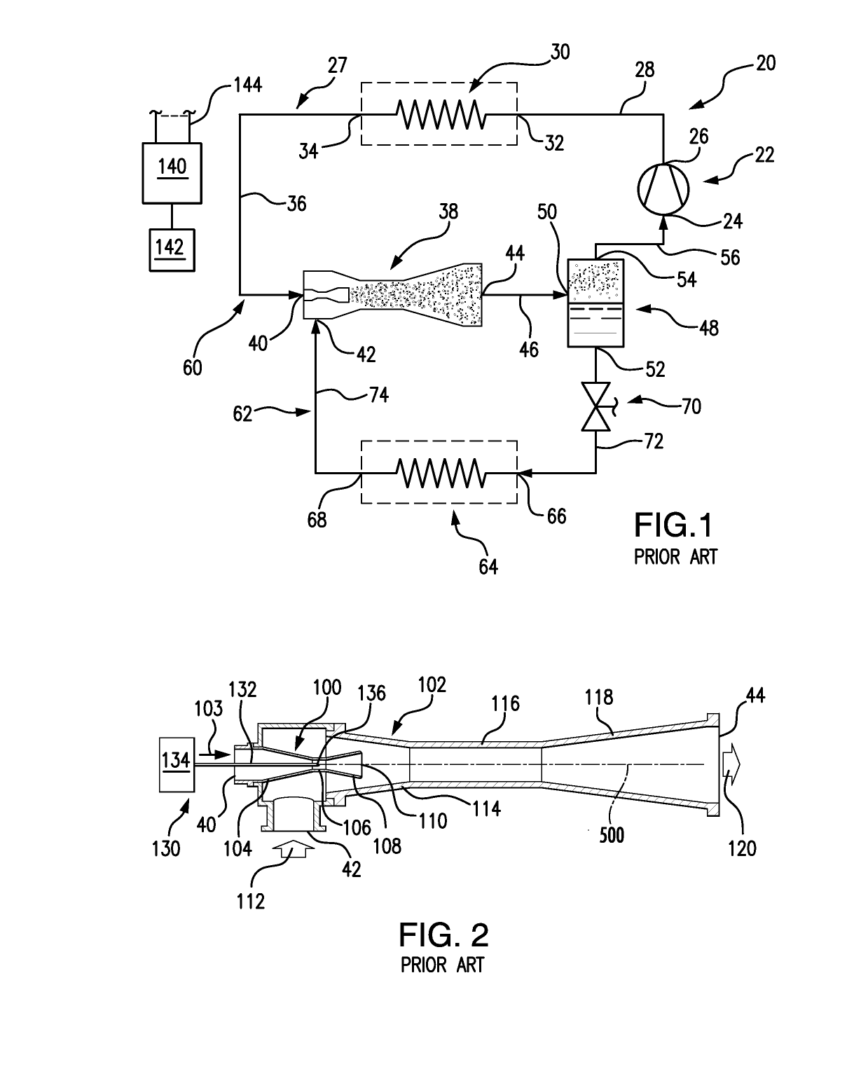

At the inlet end 206, the outlet end 208, and the leg inlet end 226, the housing may be connected to the corresponding conduits of the system of FIG. 1 with appropriate pipe/tubing fittings and/or joining techniques.

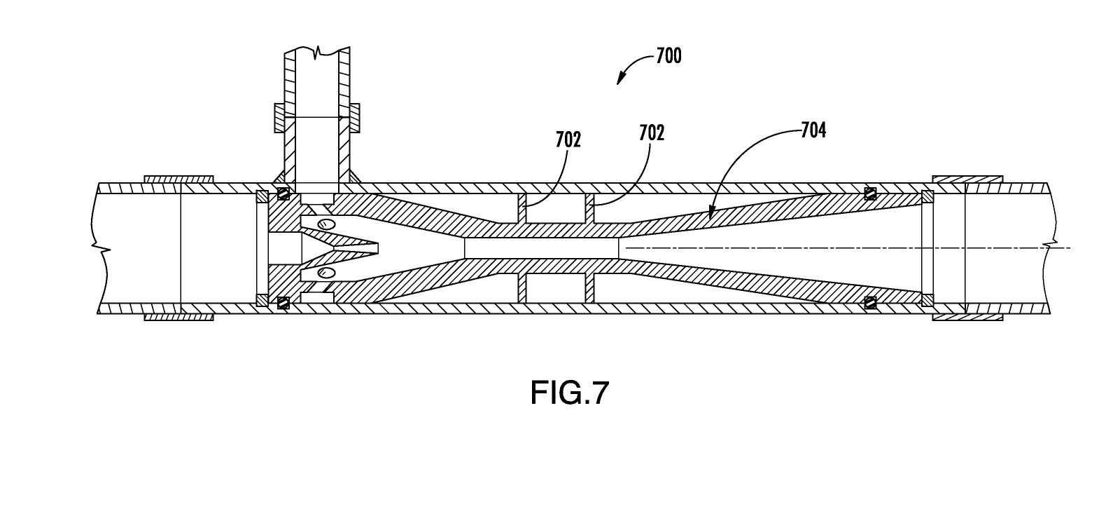

The exemplary OD surface 254, except for the described channels, is circular cylindrical about the axis 500. Alternative implementations may remove/eliminate material to depart from this (e.g., leaving axial ribs or, as in FIG. 7, circular support flanges 702 in the insert ejector 700).

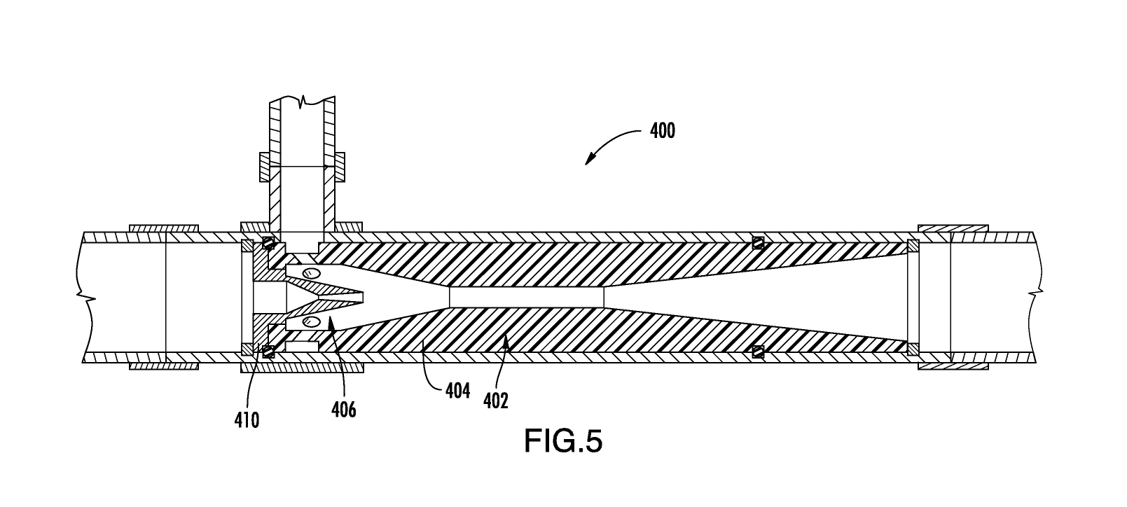

FIG. 5 shows an alternative nozzle 400 using a similar housing to that of the ejector 200 but having an insert 402 formed with two principal pieces. The insert 402 comprises a main body piece 404 which forms the secondary inlet plenum and outboard boundaries of the mixing chamber and the diffuser; whereas a motive nozzle insert 406 forms the motive nozzle. This exemplary configuration allows greater manufacturing flexibility and optimization of materials and manufacturing techniques for the particular components. For example, it allows more robust materials and/or more precise manufacturing techniques to be applied to the motive nozzle (which may be subject to higher flow velocities and require more precision) than to the plenum, mixing portion, and diffuser which require relatively low precision and are subject to less flow velocity and erosion. Overall dimensions may essentially be the same as that of the FIG. 3 embodiment. The insert 406 comprises a flange 410 forming the upstream end of the insert assembly. An underside of the flange abuts against an upstream end of the primary piece 404 and a shoulder of the piece 406 fits within an opening at the upstream end of the piece 404 to register the motive nozzle. The exemplary upstream opening of the piece 404 comprises an axial surface extending along the plenum to the convergent section. This allows relatively easy manufacture of the first piece 404. By way of example, the main body piece 404 may be formed via the rapid prototyping technique, casting technique, or molding technique described above and of the associated materials, whereas the motive nozzle insert 406 may be machined of stainless steel.

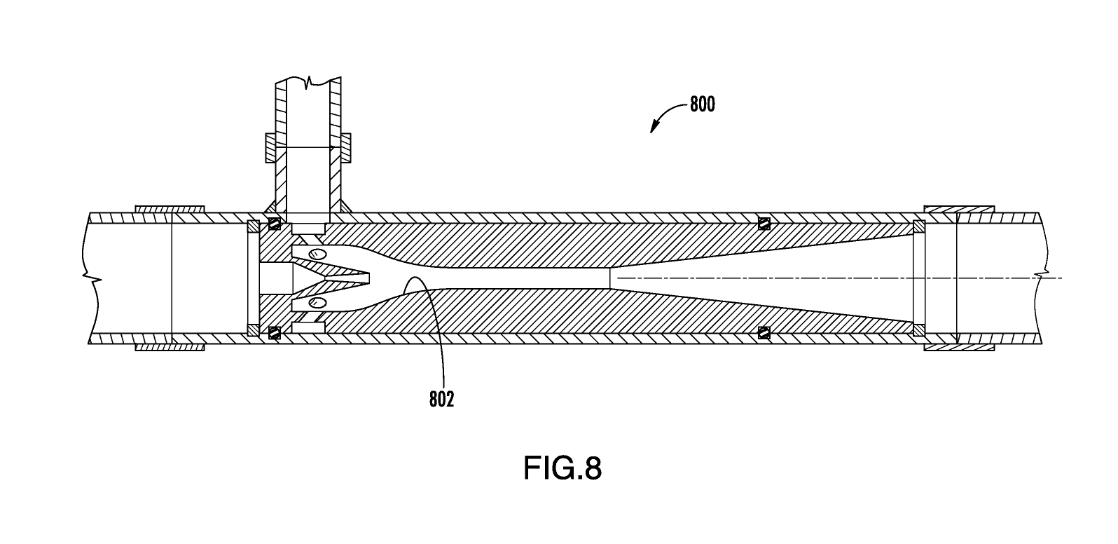

FIG. 8 shows an ejector 800 with a continuously curving transition 802 between the secondary inlet plenum and the mixer straight section. Such a curved transition may be relatively easy to manufacture via the 3D printing and selective laser sintering type processes discussed above without need for custom tooling which might be necessary to machine a similar profile.

In variations, the pipe ends 206 and 208 may not form the housing inlet and outlet. For example, the inlet or outlet may be formed by the legs of a T-fitting similar to the fitting 223. The adjacent upstream or downstream pipe end may be capped or plugged. Other variations may place elbows at one or both pipe ends. Other variations wherein the housing does not principally comprise a pipe are possible (e.g., a machined housing). Although shown without a needle, a control needle may be included along with a conventional actuator and the like.

Although an embodiment is described above in detail, such description is not intended for limiting the scope of the present disclosure. It will be understood that various modifications may be made without departing from the spirit and scope of the disclosure. For example, details of the particular refrigeration system in which the ejector is to be used may influence details of any particular implementation. Accordingly, other embodiments are within the scope of the following claims.

What is claimed is:

1. An ejector (200; 400; 600; 700; 800) comprising:
a housing (202) having an upstream end (206) and a downstream end (208) and a branch (220), a primary flowpath extending from the upstream end and a secondary flowpath passing through the branch to join the primary flowpath;
an insert (204; 402; 704) within the housing, the insert extending from an upstream end (250) to a downstream end (252) and comprising:
a motive nozzle (240) having an inlet and an outlet;
a mixer (242) at least partially downstream of the motive nozzle;
one or more passages (304) positioned such that the secondary flowpath extends through the branch and through the one or more passages to join the primary flowpath, at least one portion of the insert being of less robust material than a material of the housing.

2. The ejector (200; 400; 600; 700; 800) of claim 1 wherein:
the insert further comprises a radially outwardly open channel (302) open to the branch; and
the one or more passages (304) extend from the channel such that the secondary flowpath extends through the branch into the channel and through the one or more passages to join the primary flowpath.

3. The ejector (200; 400; 600; 700; 800) of claim 2 wherein:
the one or more passages comprise a circumferential array of a plurality of passages.

4. The ejector (200; 400; 600; 700; 800) of claim 1 wherein:
said material of the housing is, relative to said less robust material, at least one of denser, harder, stiffer, tougher, and more wear-resistant.

5. The ejector (200; 600; 700; 800) of claim 1 wherein:
the insert is essentially unitarily formed as a single piece.

6. The ejector (200; 600; 700; 800) of claim 5 wherein:
the single piece comprises a casting.

7. The ejector (400) of claim 1 wherein:
the insert consists essentially of:
a first piece (406) forming the motive nozzle; and
a second piece (404) forming the mixer and the one or more passages.

8. The ejector (400) of claim 7 wherein:
the first piece comprises a cast or machined first metal; and
the second piece comprises a non-metallic member or a second metal.

9. The ejector (200; 400) of claim 1 wherein:
the housing comprises a stainless main pipe (210) and a T-fitting (223) forming the branch.

10. The ejector (200; 400) of claim 9 wherein:
the housing upstream end (206) and housing downstream end (208) are respective ends of the stainless main pipe (210).

11. The ejector (200; 400; 600; 700; 800) of claim 1 further comprising:
an upstream retaining ring (330) engaging the upstream end of the insert and captured by an upstream annular channel in a housing interior surface; and
a downstream retaining ring (332) engaging the downstream end of the insert and captured in a downstream annular channel in the housing interior surface.

12. The ejector (200; 400; 600; 700; 800) of claim 1 wherein:
the insert comprises one or more radially outwardly open seal channels; and
one or more seals (320, 322) are at least partially captured by respective ones of the one or more radially outwardly open seal channels.

13. The ejector (200; 400; 600; 700; 800) of claim 1 wherein:
except for the one or more passages, flow contacting portings of the insert are rotationally symmetric about a central longitudinal axis (500).

14. The ejector (200; 400; 600; 700; 800) of claim 1 wherein:
the motive nozzle is a convergent-divergent nozzle; and
the mixer comprises a convergent portion (290) at least partially downstream of the motive nozzle and the insert comprises a divergent diffuser portion (244) downstream of the convergent portion.

15. A vapor compression system comprising:
a compressor (22);
a heat rejection heat exchanger (30) coupled to the compressor to receive refrigerant compressed by the compressor;
the ejector (200; 400; 600; 700; 800) of claim 1;
a heat absorption heat exchanger (64); and
a separator (48) having:
an inlet (50) coupled to the outlet of the ejector to receive refrigerant from the ejector;
a gas outlet (54); and
a liquid outlet (52).

16. A method for operating the system of claim 15, the method comprising:
compressing the refrigerant in the compressor;
rejecting heat from the compressed refrigerant in the heat rejection heat exchanger;
passing a flow of the refrigerant through the primary ejector inlet; and
passing a secondary flow of the refrigerant through the secondary inlet to merge with the primary flow.

17. The method of claim 16 wherein:
the refrigerant comprises at least 50% CO₂ by weight.

18. A method for assembling the ejector of claim 1, the method comprising:
providing the housing; and
inserting the insert into the housing.

19. The method of claim 18 wherein:
the insert is inserted as a unit; and
a retaining ring is installed to an annular channel in the housing interior surface after insertion of the insert.
